(19) United States
(12) Patent Application Publication
(10) Pub. No.: US 2006/0175725 A1
(43) Pub. Date: Aug. 10, 2006

(54) Process for granulating powders of thermoplastic polymers under improved economic conditions

(76) Inventors: Reinhard Kuehl, Bornheim (DE); Johannes-Friedrich Enderle, Frankfurt (DE); Michael Witt, Rotorua (NZ)

Correspondence Address: BASELL USA INC., INTELLECTUAL PROPERTY, 912 APPLETON ROAD, ELKTON, MD, 21921, US

(21) Appl. No.: 10/566,392

(22) PCT Filed: Jul. 14, 2004
(86) PCT No.: PCT/EP04/07760

§ 371 Date: Jan. 27, 2006

Related U.S. Application Data
(60) Provisional application No. 60/498,155, filed on Aug. 27, 2003.

(30) Foreign Application Priority Data
Jul. 29, 2003 (DE) 10334504.3

(51) Int. Cl. B29B 9/06

(52) U.S. Cl. 264/141; 264/211

(57) ABSTRACT

In a process for granulating thermoplastic polymers, in particular thermoplastic polyolefins, the polymer powder prepared in the polymerization reactor is introduced into an extruder, melted and homogenized in the extruder, then pressed through an extrusion die and granulated. According to the invention, an organic solvent or suspension medium is added to the polymer powder in an amount in the range from 0.001 to 20% by weight, prior to introduction into the extruder. The invention is particularly useful for granulating polyethylene or polypropylene, thereby increasing the polymer throughput at constant energy consumption or decreasing the energy consumption at constant polymer throughput.

The present invention relates to a process for granulating powders of thermoplastic polymers, in particular thermoplastic polyolefins, preferably polyolefins having a multimodal molar mass distribution, in which the polymer powder prepared in the polymerization reactor or reactors is introduced into an Extruder, melted and homogenized in the extruder, then pressed through an extrusion die and subsequently comminuted and cooled.

The granulation of thermoplastic polymers is known and serves to homogenize the polymer and incorporate any auxiliaries and additives such as stabilizers, colorants, agents for improving the mechanical properties, fillers and the like into the polymer. In addition, the handling of thermoplastic polymers during transport and further processing can be improved considerably by granulation compared to the handling of powders.

Apart from the direct coupling of polymerization and granulation, in which the polymer powder from the polymerization process is dried and then fed directly to the extruder, the introduction of polymer powders into the extruder at a temperature corresponding to ambient temperature is customary, particularly in compounding processes. This is due, in particular, to intermediate storage of the polymer powder in silos and the transport methods employing pneumatic conveying systems, where cooling of the powder to ambient temperature generally occurs.

Thus, in compounding, polymer powder is generally fed to the extruder as bulk material at ambient temperature. After the feed zone, the powder has to be increasingly heated in the extruder by mechanical frictional forces and finally melted bit by bit. However, the known granulation processes are still in need of improvement in respect of their throughput, the associated stressing of machines and the product quality of the granulated material.

It is an object of the present invention to provide a process for granulating thermoplastic polymers, in which the effectiveness of the homogenization during granulation is increased at a given throughput or in which the stress on the machines can be reduced, which would be reflected in a reduced energy consumption and a reduced need for repairs or reduced downtimes, or in which the product throughput of existing granulation plants can be increased, thereby maintaining the quality of homogenization and the energy consumption.

This object is achieved by a process of the generic type mentioned at the outset, in which an organic solvent or suspension medium is added to the polymer powder in an amount in the range of from 0.001 to 20% by weight, based on the weight of polymer powder plus solvent or suspension medium, prior to the introduction into the extruder.

The addition of solvent or suspension medium according to the invention is preferably effected by the polymer powder, which is prepared in suspension in the polymerization reactor, not being subjected to complete drying, but rather being dried only to such an extent that the desired amount of solvent or suspension medium is automatically established in the polymer powder. The preferred amount of solvent or suspension medium is, according to the invention, in the range from 0.0015 to 15% by weight, particularly preferably from 0.002 to 10% by weight and very particularly preferably from 0.01 to 5% by weight.

A further possible way of achieving the object using the invention is to take a previously dried polymer powder, mix this powder with an appropriate amount of organic solvent or suspension medium and then feed the mixture to the extruder for granulation.

According to the invention, organic solvent or suspension media used are saturated or alicyclic or polycyclic or aromatic hydrocarbons having from 3 to 18, preferably from 4 to 12, carbon atoms or a mixture thereof.

As a result of the presence of the amount according to the invention of solvent or suspension medium, the enthalpy of fusion of the polymer powder is reduced and the homogenization in the extruder is improved at a given energy input, which is reflected in fewer specks being observed in the polymer.

Advantageous polymers which can be granulated particularly well by the process of the invention have been found to be, in particular, standard polymers such as polyolefins, polyesters or polyamides, preferably polyethylene or polypropylene. In the case of polyethylene, the process of the invention is particularly useful when the polyethylene has a multimodal molar mass distribution, because additional swelling effects then occur in the case of this material and these lead to particularly favorable homogenization.

The process of the invention has, in particular, the advantage that the granulation can be carried out industrially under improved economic conditions. The costs of drying polymer powders are significantly reduced because the particularly energy-intensive and costly drying step for removing the last 5% of suspension medium can be dispensed with. The product quality is improved since fewer specks occur and the polymer is thermally and mechanically stressed to a lesser extent in the extruder. The machine running times for the extruders are increased because less energy is required for a given throughput of polymer powder and the machine equipment is thus subjected to lower stresses and thus requires fewer repairs. Conversely, the throughput is increased when the machines are operated at the same energy input, which improves the profitability of the process in the industrial manufacture.

### EXAMPLE 1 (ACCORDING TO THE INVENTION)

A bimodal polyethylene was prepared in suspension in hexane as suspension medium in the presence of a high-activity Ziegler catalyst in two reaction vessels connected in series. The bimodal polyethylene had a proportion of 48% by weight of low molecular weight homopolymer and a proportion of 52% by weight of high molecular weight copolymer. The density of the bimodal polyethylene was 0.955 g/cm³, while its MFI₅ was 0.35 dg/min.

The pulverulent polyethylene was subjected to the normal drying process after leaving the reaction vessel, however, the process was stopped at an early stage so that precisely 2.2% by weight of hexane remained in the polymer powder.

The powder was introduced into an extruder and processed at a constant energy input to produce granules. Films having a thickness of 25 μm were subsequently produced from the granules in a blown film process, and these were examined for the presence of specks by visual examination under a microscope. The result is shown in the following table.

### EXAMPLE 2 (COMPARATIVE EXAMPLE)

The same polymer as in Example 1 was subjected to the normal drying process after leaving the reaction vessel, but the process was continued to completion, so that less than 0.001% by weight of hexane remained in the polymer powder.

The powder which had been dried in this way was introduced into the same extruder as in Example 1 and processed to produce granules under exactly the same conditions. Films having a thickness of 25 μm were produced from the granules on the blown film plant and these were subjected to the same examination as in Example 1.

| | TABLE |
|---|---|
| | Number of specks |
| Example 1 | 396/100 cm² |
| Example 2 | 1408/100 cm² |

Process for granulating powders of thermoplastic polymers under improved economic conditions.

The present invention relates to a process for granulating powders of thermoplastic polymers, in particular thermoplastic polyolefins, preferably polyolefins having a multimodal molar mass distribution, in which the polymer powder prepared in the polymerization reactor or reactors is introduced into an Extruder, melted and homogenized in the extruder, then pressed through an extrusion die and subsequently comminuted and cooled.

The granulation of thermoplastic polymers is known and serves to homogenize the polymer and incorporate any auxiliaries and additives such as stabilizers, colorants, agents for improving the mechanical properties, fillers and the like into the polymer. In addition, the handling of thermoplastic polymers during transport and further processing can be improved considerably by granulation compared to the handling of powders.

Apart from the direct coupling of polymerization and granulation, in which the polymer powder from the polymerization process is dried and then fed directly to the extruder, the introduction of polymer powders into the extruder at a temperature corresponding to ambient temperature is customary, particularly in compounding processes. This is due, in particular, to intermediate storage of the polymer powder in silos and the transport methods employing pneumatic conveying systems, where cooling of the powder to ambient temperature generally occurs.

Thus, in compounding, polymer powder is generally fed to the extruder as bulk material at ambient temperature. After the feed zone, the powder has to be increasingly heated in the extruder by mechanical frictional forces and finally melted bit by bit. However, the known granulation processes are still in need of improvement in respect of their throughput, the associated stressing of machines and the product quality of the granulated material.

It is an object of the present invention to provide a process for granulating thermoplastic polymers, in which the effectiveness of the homogenization during granulation is increased at a given throughput or in which the stress on the machines can be reduced, which would be reflected in a reduced energy consumption and a reduced need for repairs or reduced downtimes, or in which the product throughput of existing granulation plants can be increased, thereby maintaining the quality of homogenization and the energy consumption.

This object is achieved by a process of the generic type mentioned at the outset, in which an organic solvent or suspension medium is added to the polymer powder in an amount in the range of from 0.001 to 20% by weight, based on the weight of polymer powder plus solvent or suspension medium, prior to the introduction into the extruder.

The addition of solvent or suspension medium according to the invention is preferably effected by the polymer powder, which is prepared in suspension in the polymerization reactor, not being subjected to complete drying, but rather being dried only to such an extent that the desired amount of solvent or suspension medium is automatically established in the polymer powder. The preferred amount of solvent or suspension medium is, according to the invention, in the range from 0.0015 to 15% by weight, particularly preferably from 0.002 to 10% by weight and very particularly preferably from 0.01 to 5% by weight.

A further possible way of achieving the object using the invention is to take a previously dried polymer powder, mix this powder with an appropriate amount of organic solvent or suspension medium and then feed the mixture to the extruder for granulation.

According to the invention, organic solvent or suspension media used are saturated or alicyclic or polycyclic or aromatic hydrocarbons having from 3 to 18, preferably from 4 to 12, carbon atoms or a mixture thereof.

As a result of the presence of the amount according to the invention of solvent or suspension medium, the enthalpy of fusion of the polymer powder is reduced and the homogenization in the extruder is improved at a given energy input, which is reflected in fewer specks being observed in the polymer.

Advantageous polymers which can be granulated particularly well by the process of the invention have been found to be, in particular, standard polymers such as polyolefins, polyesters or polyamides, preferably polyethylene or polypropylene. In the case of polyethylene, the process of the invention is particularly useful when the polyethylene has a multimodal molar mass distribution, because additional swelling effects then occur in the case of this material and these lead to particularly favorable homogenization.

The process of the invention has, in particular, the advantage that the granulation can be carried out industrially under improved economic conditions. The costs of drying polymer powders are significantly reduced because the particularly energy-intensive and costly drying step for removing the last 5% of suspension medium can be dispensed with. The product quality is improved since fewer specks occur and the polymer is thermally and mechanically stressed to a lesser extent in the extruder. The machine running times for the extruders are increased because less energy is required for a given throughput of polymer powder and the machine equipment is thus subjected to lower stresses and thus requires fewer repairs. Conversely, the throughput is increased when the machines are operated at the same energy input, which improves the profitability of the process in the industrial manufacture.

### EXAMPLE 1 (ACCORDING TO THE INVENTION)

A bimodal polyethylene was prepared in suspension in hexane as suspension medium in the presence of a high-activity Ziegler catalyst in two reaction vessels connected in series. The bimodal polyethylene had a proportion of 48% by weight of low molecular weight homopolymer and a proportion of 52% by weight of high molecular weight copolymer. The density of the bimodal polyethylene was 0.955 g/cm³, while its MFI₅ was 0.35 dg/min.

The pulverulent polyethylene was subjected to the normal drying process after leaving the reaction vessel, however, the process was stopped at an early stage so that precisely 2.2% by weight of hexane remained in the polymer powder.

The powder was introduced into an extruder and processed at a constant energy input to produce granules. Films having a thickness of 25 μm were subsequently produced from the granules in a blown film process, and these were examined for the presence of specks by visual examination under a microscope. The result is shown in the following table.

### EXAMPLE 2 (COMPARATIVE EXAMPLE)

The same polymer as in Example 1 was subjected to the normal drying process after leaving the reaction vessel, but the process was continued to completion, so that less than 0.001% by weight of hexane remained in the polymer powder.

The powder which had been dried in this way was introduced into the same extruder as in Example 1 and processed to produce granules under exactly the same conditions. Films having a thickness of 25 μm were produced from the granules on the blown film plant and these were subjected to the same examination as in Example 1.

Table

| | TABLE |
|---|---|
| | Number of specks |
| Example 1 | 396/100 cm² |
| Example 2 | 1408/100 cm² |

1-8. (canceled)

9. A process for granulating a polymer powder having a multimodal molar mass distribution comprising:
preparing the polymer powder in a polymerization reactor and introducing the polymer powder into an extruder;
melting and homogenizing the polymer powder in the extruder; and
pressing the polymer powder through an extrusion die, wherein an organic solvent or suspension medium is added to the polymer powder in an amount from 0.001 to 20% by weight based on a total weight of the polymer powder prior to introducing the polymer powder into the extruder.

10. The process as claimed in claim 9, wherein the organic solvent or suspension medium is prepared in suspension in the polymerization reactor; the organic solvent or suspension medium not being subjected to complete drying, wherein the organic solvent or suspension medium is in the polymer powder in an amount from 0.001 to 20% by weight.

11. The process as claimed in claim 9, wherein the organic solvent or suspension medium is introduced to a dry polymer powder, wherein the organic solvent or suspension medium is in the polymer powder in an amount from 0.001 to 20% by weight.

12. The process as claimed in claim 9, wherein the organic solvent or suspension medium is introduced to the polymer powder in the extruder, wherein the organic solvent or suspension medium is in the polymer powder in an amount from 0.001 to 20% by weight.

13. The process as claimed in claim 9, wherein the organic solvent or suspension medium in the polymer powder is in an amount

14. The process as claimed in claim 9, wherein the organic solvent or suspension medium in the polymer powder is in an amount from 0.002 to 10% by weight.

15. The process as claimed in claim 9, wherein the organic solvent or suspension medium in the polymer powder is in an amount from 0.01 to 5% by weight.

16. The process as claimed in claim 9, wherein the organic solvent or suspension medium is a saturated or cyclic, or polycyclic or aromatic hydrocarbon having from 3 to 18 carbon atoms.

17. The process as claimed in claim 16, wherein the organic solvent or suspension medium has from 4 to 12 carbon atoms.

18. The process as claimed in claim 9, wherein the polymer powder comprises a thermoplastic polymer.

19. The process as claimed in claim 9, wherein the polymer powder comprises polyethylene.
